(19) United States
(12) Patent Application Publication
(10) Pub. No.: US 2011/0142207 A1
(43) Pub. Date: Jun. 16, 2011

(54) METHOD AND APPARATUS FOR NOTIFYING EMERGENCY RESPONSE ORGANIZATION OF EMERGENCY MESSAGE CLUSTER

(75) Inventors: Stuart O. Goldman, Scottsdale, AZ (US); Karl F. Rauscher, Emmaus, PA (US)

(73) Assignee: ALCATEL-LUCENT USA INC., Murray Hill, NJ (US)

(21) Appl. No.: 12/638,299

(22) Filed: Dec. 15, 2009

(51) Int. Cl. H04M 11/04

(52) U.S. Cl. 379/45

(57) ABSTRACT

A method for notifying an emergency response organization of an emergency message cluster may include: a) detecting emergency messages directed to a first emergency response organization during a time window; b) detecting an emergency message cluster to the first emergency response organization at least in part by determining a quantity of emergency messages detected during the first time window exceeds a threshold value; and c) sending a notification message to a second emergency response organization in response to detecting the emergency message cluster. A network node associated with the method may include a switching module for handling the emergency messages in normal fashion, a message detecting logic for detecting emergency messages to the first emergency response organization, a cluster detecting logic for detecting the emergency message cluster, and an output module for sending the notification message.

### BACKGROUND

This disclosure relates to a method and apparatus for notifying an emergency response organization of an emergency message cluster at another emergency response organization. For example, this disclosure describes exemplary embodiments for notifying a law enforcement organization or another specialized emergency response organization of an emergency message cluster at a public safety answering point (PSAP) and will be thus described with specific reference thereto. However, it will be appreciated that the disclosed concepts may have usefulness in notifying any emergency response organization of an emergency message cluster at any other emergency response organization. Moreover, multiple emergency response organization can be notified of emergency message clusters. Thresholds for emergency message quantities, time, and geographic areas can be used to detect emergency message clusters in various suitable combinations. Where multiple emergency response organizations are to be notified, the thresholds can be set at different levels for different organizations based on the service provided by the organization to be notified.

By way of background, the primary purpose of emergency messages (e.g., 911 calls in the United States, 112 calls in the European Union) is to connect an originator of the emergency message with a message taker (e.g., call taker) at an emergency response organization (e.g., PSAP) so that the originator can request assistance for an emergency, such as medical, fire, or rescue emergency. Depending on the nature of the emergency, the message taker focuses on dispatching assistance to the specific message originator.

However, the overall cause of the emergency and the larger scale nature of the emergency may not be apparent from the exchange with the emergency message originator. For example, the message originator may have a medical emergency due to a traffic accident. However, the traffic accident may be due to a toxic waste or hazardous chemical spill. The nature of the hazardous materials (HAZMAT) and traffic emergencies may not be readily apparent until well after an emergency response is dispatched for the specific emergency message.

Moreover, when a problem, such as a road being blocked by an accident or fire for instance, is reported, the authorities responsible for addressing certain aspects of the emergency may not be alerted immediately. Even if certain authorities find out about the problem from the emergency response organization that received the emergency message, delays in notifying the authorities may be introduced due to congestion of emergency messages at the original message center, delays by message takers in dispatching authorities, and difficulties in getting through to the authorities to be dispatched.

Based on the foregoing, a solution that expedites notification of emergency response organizations of certain emergency conditions is desirable. Additionally, a solution that that overcomes at least a portion of the drawbacks associated with emergency message congestion and delays in responses to emergencies is desirable.

### SUMMARY

In one aspect, a method for notifying an emergency response organization of an emergency message cluster is provided. In one embodiment, the method includes: a) detecting emergency messages directed to a first emergency response organization at a network node in a communication network during a first time window, wherein the emergency messages are originated by user devices and directed to a first network address associated with one or more first destination devices at the first emergency response organization via the communication network through at least the network node; b) detecting a first emergency message cluster to the first emergency response organization at least in part by determining a quantity of emergency messages detected during the first time window exceeds a first threshold value; and c) sending a first notification message to a second emergency response organization in response to detecting the first emergency message cluster, wherein the first notification message is originated by the network node and directed to a second network address associated with one or more second destination devices at the second emergency response organization via the communication network.

In another aspect, an apparatus within a communication network for notifying an emergency response organization of an emergency message cluster is provided. In one embodiment, the apparatus includes: a switching module for handling emergency messages originated by user devices via the communication network, wherein the emergency messages are directed to a first network address associated with one or more first destination devices at a first emergency response organization via the communication network; a message detecting logic in operative communication with the switching module for detecting the emergency messages directed to the first emergency response organization during a first time window; a cluster detecting logic in operative communication with the message detecting logic for detecting a first emergency message cluster to the first emergency response organization at least in part by determining a quantity of emergency messages detected during the first time window exceeds a first threshold value; and an output module in operative communication with the cluster detecting logic for sending a first notification message to a second emergency response organization in response to the first emergency message cluster being detected, wherein the first notification message is originated by the output module and directed to a second network address associated with one or more second destination devices at the second emergency response organization via the communication network.

In yet another aspect, a method for notifying an emergency response organization of an emergency message cluster is provided. In one embodiment, the method includes: a) detecting emergency messages directed to a first emergency response organization at a network node in a communication network during a chronological time period, wherein the emergency messages are originated by user devices and directed to a first network address associated with one or more first destination devices at the first emergency response organization via the communication network through at least the network node; b) analyzing the detected emergency messages in relation to the chronological time period; c) determining a normal amount of emergency messages to the first emergency response organization in relation to the chronological time period; d) determining an abnormal amount of emergency messages to the first emergency response organization in relation to the chronological time period, wherein the abnormal amount is offset from the normal amount by a margin defining a cluster threshold at which the first emergency response organization desires to notify a second emergency response organization of emergency message clusters; and e) setting a first threshold value to the abnormal amount for subsequent detecting of emergency message clusters at the first emergency response organization.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a flow chart of an exemplary embodiment of a process for notifying an emergency response organization of an emergency message cluster;

FIG. 2, in conjunction with FIG. 1, is a flow chart of another exemplary embodiment of a process for notifying an emergency response organization of an emergency message cluster;

FIG. 3 is a block diagram of an exemplary embodiment of a network node for notifying an emergency response organization of an emergency message cluster;

FIG. 4 is a block diagram of another exemplary embodiment of a network node for notifying an emergency response organization of an emergency message cluster;

FIG. 5 is a block diagram of an exemplary embodiment of a destination serving node for notifying an emergency response organization of an emergency message cluster;

FIG. 6 is a block diagram of an exemplary embodiment of an origination serving node for notifying an emergency response organization of an emergency message cluster;

FIG. 7 is a block diagram of yet another exemplary embodiment of a network node for notifying an emergency response organization of an emergency message cluster;

FIG. 8 is a flow chart of yet another exemplary embodiment of a process for notifying an emergency response organization of an emergency message cluster.

### DETAILED DESCRIPTION

Various embodiments of methods and network nodes for notifying an emergency response organization of an emergency message cluster are disclosed herein. Certain embodiments take advantage of global positioning system (GPS) and other location determining capabilities in mobile phones and other communication devices. For example, if a cluster of emergency messages arrives from the same cell or sector within a given time frame, this is an implicit indicator that there may be conditions that certain emergency response organizations should investigate in addition to and separate from dispatching a specific response to the originator of the emergency message.

Possible implementations for notifying certain emergency response organizations could be based in a destination serving node (e.g., a public safety answering point (PSAP) switch) for the original emergency messages or in an origination serving node (e.g., a multi-services operator (MSO)) for the messages. The functionality in these implementation is similar but the collecting, analyzing, and notifying point in the communication network may be different depending on if it is destination or origination-based.

When an emergency message, such as a 911 call (i.e., the emergency service access code (SAC) in North America) or a 112 call (i.e., the emergency SAC in European Union), is originated, the network node (MSO or PSAP) may receive location information along with the message from the user equipment or may retrieve location information from an alternate source that relates the originating network address (e.g., telephone or directory number) to registered or current location information. If the amount of emergency messages from within a given predefined geographic boundary in a defined period of time exceeds a predefined threshold, the network node may automatically send an urgent pre-scripted notification message to an emergency response organization that has been pre-selected for those circumstances, such as a law enforcement authority. The notification message may contain various information that may be useful to the emergency response organization in implementation an overall response to the emergency, such as the number and distribution of emergency messages in relation to the geographic area as well as public facilities and known events relating to the distribution of messages.

In response to the notification message, the emergency response organization could follow a protocol that was previously created for such a situation, such as sending a helicopter or police car to the area to ascertain the situation. Alternatively, if cameras are pre-positioned in the area, they could be used by the alerted emergency response organization to ascertain the situation. The response protocol to the notification message could also include interaction with the PSAP and other emergency response organizations. The notification message could be by a variety of means, such as a voice call, a text message, a multi-media message, an e-mail message, or any other suitable message type agreed upon between the emergency response organization receiving the emergency message cluster (e.g., PSAP) and the emergency response organization to which the notification message is directed (e.g., law enforcement authority).

Additionally, pre-defined thresholds for the quantity of emergency messages, select time periods, and select geographic areas can be based on collection of empirical information from past circumstances to determine normal and abnormal conditions. In order to determine the statistical control limits of a “normal” number of emergency messages, the same network node used to monitor for a special situation, can passively collect data to be used for determining “intelligent thresholds” for determining levels of message volumes. These thresholds make the interpretation of the special situations easier to identify and act on with more confidence. The intelligent thresholds may allow the emergency response organizations to avoid over-reaction to normal statistical emergency message patterns which could have a “numbing” affect on sensitivity to a “real” special situation. The analysis engine used to calculate intelligent thresholds can accept parameters like time of day to deal with anticipated rush hour activity, scheduled times for large sporting events or political rallies to anticipate large crowds where advanced placement of emergency staff is already planned, etc.

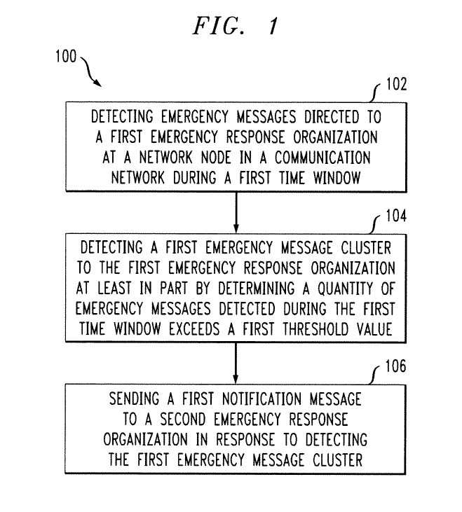

Referring now to the drawings wherein the showings are for purposes of illustrating the exemplary embodiments only and not for purposes of limiting the claimed subject matter, FIG. 1 depicts an exemplary embodiment of a process 100 for notifying an emergency response organization of an emergency message cluster begins at 102 where emergency messages directed to a first emergency response organization at a network node in a communication network during a first time window may be detected. The emergency messages may be originated by user devices and directed to a first network address associated with one or more first destination devices at the first emergency response organization via the communication network through at least the network node.

At 104, a first emergency message cluster to the first emergency response organization may be detected at least in part by determining a quantity of emergency messages detected during the first time window exceeds a first threshold value. Next, a first notification message may be sent to a second emergency response organization in response to detecting the first emergency message cluster (106). The first notification message may be originated by the network node and directed to a second network address associated with one or more second destination devices at the second emergency response organization via the communication network.

In one embodiment, the first notification message in 106 may include information indicative of a geographic area representative of at least a portion of a coverage area serviced by the network node, an elapsed time in relation to the first time window and detection of the first emergency message cluster, and the quantity of emergency messages detected in relation to the first time window and detection of the first emergency message cluster.

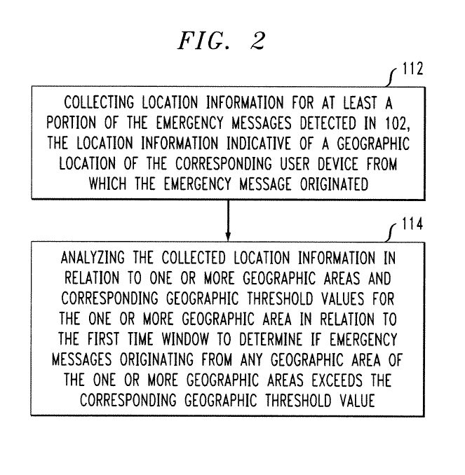

With reference to FIGS. 1 and 2, another exemplary embodiment of the process 100 includes 112 where location information for at least a portion of the emergency messages detected in 102 is collected. The location information indicative of a geographic location of the corresponding user device from which the emergency message originated. At 114, the collected location information is analyzed in relation to one or more geographic areas and corresponding geographic threshold values for the one or more geographic area in relation to the first time window to determine if emergency messages originating from any geographic area of the one or more geographic areas exceed the corresponding geographic threshold value. In this embodiment, the first emergency message cluster in 104 may be detected at least in part by determining that emergency messages originating from at least one geographic area of the one or more geographic areas during the first time window exceeded the corresponding threshold value. The first notification message in 106 in this embodiment may include the corresponding location information for the at least one geographic area contributing to detection of the first emergency message cluster in 104.

In another exemplary embodiment of the process 100, the location information in 112 may accompany the corresponding emergency messages at the network node. In this embodiment, the process 100 may include capturing the accompanying location information from the corresponding emergency messages. The accompanying location information may include a GPS coordinate for the corresponding user device, a wireless network coordinate for the corresponding user device, a serving sector antenna for the corresponding user device, a serving base station for the corresponding user device, a serving switching center for the corresponding user device, a registered location for the corresponding user device, a registered location for a subscriber operating the corresponding user device, or any suitable location information. GPS coordinates may include x,y coordinates (latitude, longitude) or x,y,z coordinates (latitude, longitude, elevation) resolved by a GPS receiver for a user device. Wireless network coordinates may provide geographic location based on strengths of signals received by a user device from two or more base stations using triangulation techniques. Many forms of location information can be cross-referenced to address information or other suitable location representations by databases used for such cross referencing.

The accompanying location information in the embodiment being described may be combined with the corresponding emergency message by at least one of the corresponding user device, a serving base station for the corresponding user device, a serving switching center for the corresponding user device, a first internet service provider (ISP) for the corresponding user device, a second ISP for a subscriber operating the corresponding user device, a first voice over internet protocol (VoIP) service provider for the corresponding user device, a second VoIP service provider for the subscriber operating the corresponding user device, a first e-mail service provider for the corresponding user device, and a second e-mail service provider for the subscriber operating the corresponding user device.

In yet another exemplary embodiment of the process 100, an originating network address may accompany emergency messages at the network node for which the location information in 112 is collected. In this embodiment, the process 100 may include retrieving the location information in 112 from a database accessible to the network node via the communication network based at least in part on the corresponding originating network address. The database may relate the originating network address to the corresponding location information. In the embodiment being described, the retrieved location information may include at least one of a registered location for the corresponding user device and a registered location for a subscriber operating the corresponding user device. The originating network address and corresponding location information in the embodiment being described may be maintained in the database by at least one of a landline telephone service provider, an ISP, a VoIP service provider, an e-mail service provider, and a wireless service provider.

With continued reference to FIG. 1, in still yet another exemplary embodiment of the process 100, the emergency messages may include a voice call, a text message, a multi-media message, an e-mail message, or any suitable message type in any combination. In another embodiment, the first emergency response organization may include a PSAP, an emergency call center, a law enforcement organization, a fire emergency response organization, a medical emergency response organization, a search emergency response organization, a rescue emergency response organization, a hazardous materials (HAZMAT) emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In another embodiment, the network node may include a destination serving node for the one or more first destination devices at the first emergency response organization. In the embodiment being described, the destination serving node may include a PSAP switching center, a private branch exchange (PBX), a circuit switching center, a mobile switching center (MSC), a base station, a packet switching center, an ISP, a VoIP service provider, an e-mail service provider, an MSO, or any suitable type of destination serving node. Of course, a given destination serving node may include multiple types of serving nodes in any suitable combination.

In yet another embodiment, the network node may include an origination serving node for the user devices from which the emergency messages are originated. In the embodiment being described, the origination serving node may include an MSO, a circuit switching center, an MSC, a base station, a packet switching center, an ISP, a VoIP service provider, an e-mail service provider, a PBX, or any suitable type of origination serving node. Of course, a given origination serving node may include multiple types of serving nodes in any suitable combination.

In another embodiment, the communication network may include a public switched telephone network (PSTN), a wireless telephone network, a cellular telephone network, a satellite telephone network, an internet protocol (IP) network, a VoIP network, a local area network (LAN), a wide area network (WAN), a metropolitan area network (MAN), or any suitable type of communication network in any combination. In yet another embodiment, the first time window may be defined by a predetermined fixed duration that shifts in relation to perpetual time such that the quantity of emergency messages associated with the first time window are counted on a first-in-first-out basis. In the embodiment being described, the first emergency message cluster may be detected after the quantity of emergency messages exceeds the first threshold value without having to wait for the first time window to expire.

In still yet another embodiment, the user devices may include a landline telephone, a wireless telephone, a cellular telephone, a satellite telephone, a portable computer device, a computer work station, an IP telephone, or any suitable user device in any combination. In another embodiment, the first network address may include an SAC, a directory number, a telephone number, an IP address, an e-mail address, or any suitable network address. Of course, a given network address may include multiple types of network addresses in any suitable combination. In yet another embodiment, the one or more first destination devices include may include a landline telephone, a wireless telephone, a cellular telephone, a satellite telephone, a portable computer device, a computer work station, an IP telephone, or any suitable destination device in any combination.

In still yet another embodiment, the first notification message may include a voice call, a text message, a multi-media message, an e-mail message, or any suitable type of message. Of course, a given notification message may include multiple types of messages in any suitable combination. In another embodiment, the second emergency response organization may include a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In yet another embodiment, the second network address may include an SAC, a directory number, a telephone number, an IP address, an e-mail address, or any suitable network address. Of course, a given network address may include multiple types of network addresses in any suitable combination. In still yet another embodiment, the one or more second destination devices include a landline telephone, a wireless telephone, a cellular telephone, a satellite telephone, a portable computer device, a computer work station, an IP telephone, or any suitable destination device in any combination. In another embodiment, the first notification message in 106 facilitates initiation of a predetermined response protocol by the second emergency response organization in relation to the first emergency message cluster. For example, the response protocol may include initiation of surveillance for the geographic area and deployment of emergency response personnel and equipment. Surveillance may be accomplished by pre-positioned cameras, pre-positioned sensors, or by manned or unmanned vehicles, aircraft, or watercraft in any combination. Similarly, deployment of emergency response personnel and equipment may be by vehicles, aircraft, or watercraft in any combination.

In yet another embodiment, the process 100 for notifying an emergency response organization of an emergency message cluster may include detecting a second emergency message cluster to the first emergency response organization at least in part by determining the quantity of emergency messages detected during the first time window exceeds a second threshold value. In the embodiment being described, a second notification message may be sent to the second emergency response organization in response to detecting the second emergency message cluster. The second notification message may be originated by the network node and directed to the second network address associated with the one or more second destination devices at the second emergency response organization via the communication network.

In still yet another embodiment, the process 100 for notifying an emergency response organization of an emergency message cluster may include detecting a second emergency message cluster to the first emergency response organization at least in part by determining the quantity of emergency messages detected during the first time window exceeds a second threshold value. In the embodiment being described, a second notification message may be sent to a third emergency response organization in response to detecting the second emergency message cluster. The second notification message may be originated by the network node and directed to a third network address associated with one or more third destination devices at the third emergency response organization via the communication network.

In another embodiment, the process 100 for notifying an emergency response organization of an emergency message cluster may include detecting the emergency messages in 102 during a second time window. In the embodiment being described, a second emergency message cluster to the first emergency response organization may be detected at least in part by determining a quantity of emergency messages detected during the second time window exceeds a second threshold value. A second notification message may be sent to the second emergency response organization in response to detecting the second emergency message cluster. The second notification message may be originated by the network node and directed to the second network address associated with the one or more second destination devices at the second emergency response organization via the communication network.

In the embodiment being described, the process 100 may include detecting a third emergency message cluster to the first emergency response organization at least in part by determining the quantity of emergency messages detected during the second time window exceeds a third threshold value. In this embodiment, a third notification message may be sent to the second emergency response organization in response to detecting the third emergency message cluster. The third notification message may be originated by the network node and directed to the second network address associated with the one or more second destination devices at the second emergency response organization via the communication network.

Alternatively, in the embodiment being described, the process 100 may include detecting a third emergency message cluster to the first emergency response organization at least in part by determining the quantity of emergency messages detected during the second time window exceeds a third threshold value. In this embodiment, a third notification message may be sent to a third emergency response organization in response to detecting the third emergency message cluster. The third notification message may be originated by the network node and directed to a third network address associated with one or more third destination devices at the third emergency response organization via the communication network.

In yet another embodiment, the process 100 for notifying an emergency response organization of an emergency message cluster may include detecting the emergency messages in 102 during a second time window. In the embodiment being described, a second emergency message cluster to the first emergency response organization may be detected at least in part by determining a quantity of emergency messages detected during the second time window exceeds a second threshold value. A second notification message may be sent to a third emergency response organization in response to detecting the second emergency message cluster. The second notification message may be originated by the network node and directed to a third network address associated with one or more third destination devices at the third emergency response organization via the communication network.

In the embodiment being described, the process 100 may include detecting a third emergency message cluster to the first emergency response organization at least in part by determining the quantity of emergency messages detected during the second time window exceeds a third threshold value. In this embodiment, a third notification message may be sent to the third emergency response organization in response to detecting the third emergency message cluster. The third notification message may be originated by the network node and directed to the third network address associated with the one or more third destination devices at the third emergency response organization via the communication network.

In yet another embodiment, the process 100 for notifying an emergency response organization of an emergency message cluster may include analyzing the emergency messages detected in 102 in relation to a chronological time period. In the embodiment being described, a normal amount of emergency messages to the first emergency response organization may be determined in relation to the chronological time period. Then, an abnormal amount of emergency messages to the first emergency response organization may be determined in relation to the chronological time period. The abnormal amount may be offset from the normal amount by a margin defining a cluster threshold at which the first emergency response organization desires to notify the second emergency response organization of emergency message clusters. Next, the process 100 may further include setting the first time window to the chronological time period and setting the first threshold value to the abnormal amount.

In the embodiment being described, the process 100 may include analyzing the emergency messages detected in 102 in relation to a predetermined calendar cycle. For example, calendar cycles may include a daily cycle for each day, each week, each month or each year; a weekly cycle for each week, each month or each year; a monthly cycle for each month or each year; or an annual cycle for each year. Next, the normal amount of emergency messages in relation to chronological segments of the predetermined calendar cycle may be determined. The chronological segment may be any time period less than the overall time for the predetermined calendar cycle and may be varied over the predetermined calendar cycle. The abnormal amount of emergency messages for each chronological segment may be determined. The first threshold value may be varied over the predetermined calendar cycle in relation to the abnormal amounts determined for consecutive chronological segments.

Alternatively, in the embodiment being described, the process 100 may include analyzing the emergency messages detected in 102 in relation to a predetermined schedule of events within a coverage area of the first emergency response organization. For example, events at a public stadium, arena, convention center, or another public facility may be scheduled; events at schools and churches may be scheduled; and work schedules (e.g., shift changes, work holidays, etc.) that have a significant impact on a geographic area may be scheduled. Next, the normal amount of emergency messages in relation to chronological segments of the predetermined schedule of events may be determined. The chronological segment may be any time period less than the overall time for the predetermined schedule and may be varied over the predetermined schedule. The abnormal amount of emergency messages for each chronological segment may be determined. The first threshold value may be varied over the predetermined schedule of events in relation to the abnormal amounts determined for consecutive chronological segments.

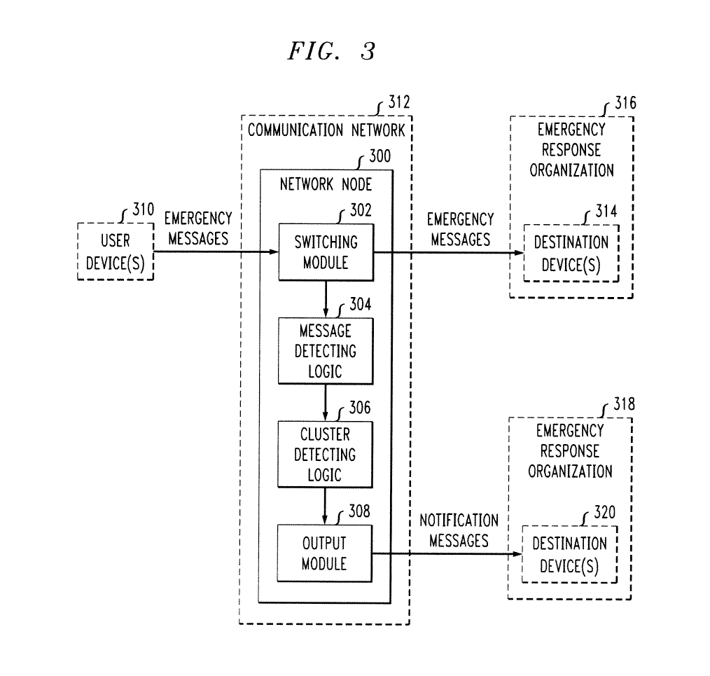

With reference to FIG. 3, an exemplary embodiment of a network node 300 for notifying an emergency response organization of an emergency message cluster may include a switching module 302, a message detecting logic 304, a cluster detecting logic 306, and an output module 308. The switching module 302 may handle emergency messages originated by user devices 310 via the communication network 312. The emergency messages may be directed to a first network address associated with one or more first destination devices 314 at a first emergency response organization 316 via the communication network 312. The message detecting logic 304 may be in operative communication with the switching module 302 and may detect the emergency messages directed to the first emergency response organization 316 during a first time window.

The cluster detecting logic 306 may be in operative communication with the message detecting logic 304 and may detect a first emergency message cluster to the first emergency response organization 316 at least in part by determining a quantity of emergency messages detected during the first time window exceeds a first threshold value. The output module 308 may be in operative communication with the cluster detecting logic 306 and may send a first notification message to a second emergency response organization 318 in response to the first emergency message cluster being detected. The first notification message may be originated by the output module 308 and directed to a second network address associated with one or more second destination devices 320 at the second emergency response organization 318 via the communication network 312.

In one embodiment, the first notification message may include information indicative of a geographic area representative of at least a portion of a coverage area serviced by the network node 300, an elapsed time in relation to the first time window and detection of the first emergency message cluster, and the quantity of emergency messages detected in relation to the first time window and detection of the first emergency message cluster.

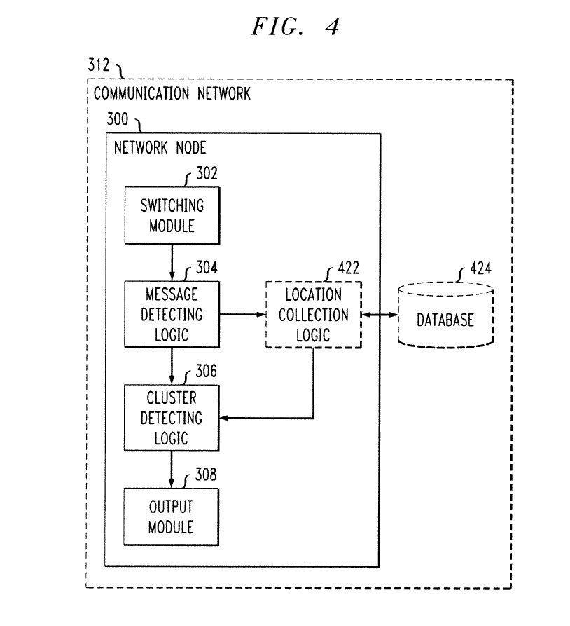

With reference to FIGS. 3 and 4, another exemplary embodiment of the network node 300 may include a location collection logic 422 in operative communication with the message detecting logic 304. The location collection logic 422 may collect location information for at least a portion of the emergency messages. The location information may be indicative of a geographic location of the corresponding user device 310 from which the emergency message originated. In the embodiment being described, the cluster detecting logic 306 may be in operative communication with the location collection logic 422 and may analyze the collected location information in relation to one or more geographic areas and corresponding geographic threshold values for the one or more geographic area in relation to the first time window to determine if emergency messages originating from any geographic area of the one or more geographic areas exceed the corresponding geographic threshold value. The first emergency message cluster may be detected at least in part by determining that emergency messages originating from at least one geographic area of the one or more geographic areas during the first time window exceeded the corresponding threshold value. The first notification message may include the corresponding location information for the at least one geographic area contributing to detection of the first emergency message cluster.

In another embodiment of the network node 300, the location information may accompany the corresponding emergency messages and the location collection logic 322 may capture the accompanying location information from the corresponding emergency messages. In the embodiment being described, the accompanying location information may include a GPS coordinate for the corresponding user device, a wireless network coordinate for the corresponding user device, a serving sector antenna for the corresponding user device, a serving base station for the corresponding user device, a serving switching center for the corresponding user device, a registered location for the corresponding user device, a registered location for a subscriber operating the corresponding user device, or any suitable location information. GPS coordinates may include x,y coordinates (latitude, longitude) or x,y,z coordinates (latitude, longitude, elevation) resolved by a GPS receiver for a user device. Wireless network coordinates may provide geographic location based on strengths of signals received by a user device from two or more base stations using triangulation techniques. Many forms of location information can be cross-referenced to address information or any suitable location representation by databases used for such cross referencing.

The accompanying location information in the embodiment being described may be combined with the corresponding emergency message by at least one of the corresponding user device 310, a serving base station for the corresponding user device, a serving switching center for the corresponding user device, a first ISP for the corresponding user device, a second ISP for a subscriber operating the corresponding user device, a first VoIP service provider for the corresponding user device, a second VoIP service provider for the subscriber operating the corresponding user device, a first e-mail service provider for the corresponding user device, or a second e-mail service provider for the subscriber operating the corresponding user device.

In yet another embodiment of the network node 300, an originating network address may accompany the emergency messages. In this embodiment, the location collection logic 422 may be in operative communication with a database 424 and may retrieve the location information from the database 424 via the communication network 312 based at least in part on the corresponding originating network address. The database 424 may relate the originating network address to the corresponding location information. In the embodiment being described, the retrieved location information may include at least one of a registered location for the corresponding user device and a registered location for a subscriber operating the corresponding user device. The originating network address and corresponding location information in the embodiment being described may be maintained in the database 424 by at least one of a landline telephone service provider, an ISP, a VoIP service provider, an e-mail service provider, and a wireless service provider.

In still yet another embodiment of the network node 300, the emergency messages may include a voice call, a text message, a multi-media message, an e-mail message, or any suitable message type in any combination. In another embodiment, the first emergency response organization may include a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

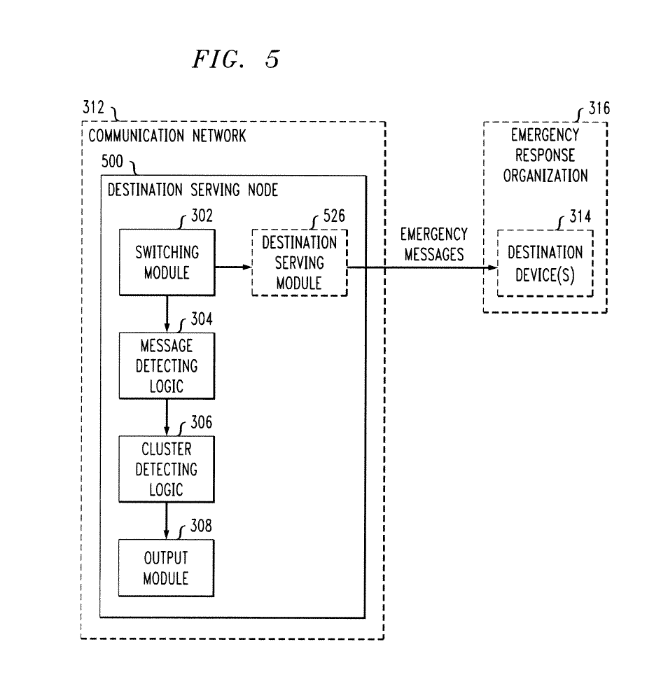

With reference to FIGS. 3 and 5, the network node 300 may comprise a destination serving node 500. An exemplary embodiment of the destination serving node 500 may include a destination serving module 526 in operative communication with the switching module 302. The destination serving module 526 may serve the first emergency response organization 316 and may send the emergency messages to the one or more first destination devices 314 via the communication network 312. In the embodiment being described, the destination serving node 500 may include a PSAP switching center, a PBX, a circuit switching center, an MSC, a base station, a packet switching center, an ISP, a VoIP service provider, an e-mail service provider, an MSO, or any suitable type of destination serving node. Of course, a given destination serving node 500 may include multiple types of serving nodes in any suitable combination.

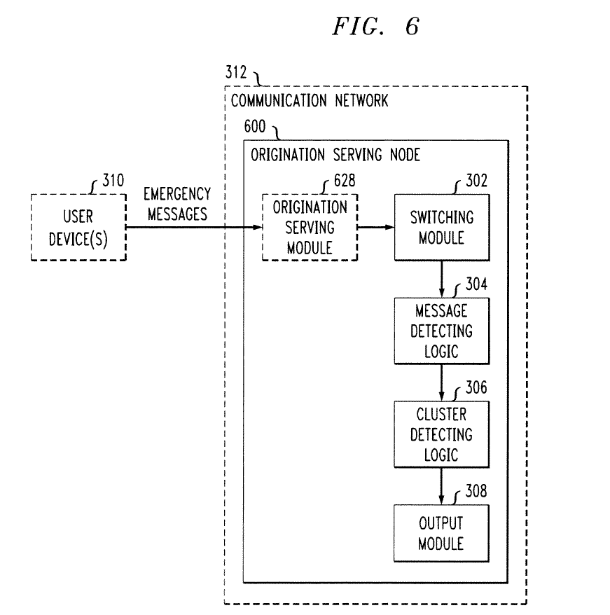

With reference to FIGS. 3 and 6, the network node 300 may comprise an origination serving node 600. An exemplary embodiment of the origination serving node 600 may include an origination serving module 628 in operative communication with the switching module 302. The origination serving module 628 may serve the user devices 310 from which the emergency messages are originated and may receive the emergency messages from the user devices 310 via the communication network 312. In the embodiment being described, the origination serving node 600 may include an MSO, a circuit switching center, an MSC, a base station, a packet switching center, an ISP, a VoIP service provider, an e-mail service provider, a PBX, or any suitable type of origination serving node. Of course, a given origination serving node 600 may include multiple types of serving nodes in any suitable combination.

With continuing reference to FIG. 3, the communication network 312 may include a PSTN, a wireless telephone network, a cellular telephone network, a satellite telephone network, an IP network, a VoIP network, a LAN, a WAN, a MAN, or any suitable type of communication network in any combination. In yet another embodiment of the network node 300, the first time window may be defined by a predetermined fixed duration that shifts in relation to perpetual time such that the quantity of emergency messages associated with the first time window are counted on a first-in-first-out basis. In the embodiment being described, the first emergency message cluster may be detected after the quantity of emergency messages exceeds the first threshold value without having to wait for the first time window to expire.

In still yet another embodiment, the user devices 310 may include a landline telephone, a wireless telephone, a cellular telephone, a satellite telephone, a portable computer device, a computer work station, an IP telephone, or any suitable user device in any combination. In another embodiment, the first network address may include an SAC, a directory number, a telephone number, an IP address, an e-mail address, or any suitable network address. Of course, a given network address may include multiple types of network addresses in any suitable combination. In yet another embodiment, the one or more first destination devices 314 may include a landline telephone, a wireless telephone, a cellular telephone, a satellite telephone, a portable computer device, a computer work station, an IP telephone, or any suitable destination device in any combination.

In still yet another embodiment, the first notification message may include a voice call, a text message, a multi-media message, an e-mail message, or any suitable type of message. Of course, a given notification message may include multiple types of messages in any suitable combination. In another embodiment, the second emergency response organization 318 may include a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In yet another embodiment, the second network address may include an SAC, a directory number, a telephone number, an IP address, an e-mail address, or any suitable network address. Of course, a given network address may include multiple types of network addresses in any suitable combination. In still yet another embodiment, the one or more second destination devices 320 may include a landline telephone, a wireless telephone, a cellular telephone, a satellite telephone, a portable computer device, a computer work station, an IP telephone, or any suitable destination device in any combination. In another embodiment, the first notification message facilitates initiation of a predetermined response protocol by the second emergency response organization 318 in relation to the first emergency message cluster. For example, the response protocol may include initiation of surveillance for the geographic area and deployment of emergency response personnel and equipment. Surveillance may be accomplished by pre-positioned cameras, pre-positioned sensors, or by manned or unmanned vehicles, aircraft, or watercraft in any combination. Similarly, deployment of emergency response personnel and equipment may be by vehicles, aircraft, or watercraft in any combination.

With continuing reference to FIG. 3, in another exemplary embodiment of the network node 300, the cluster detecting logic 306 may detect a second emergency message cluster to the first emergency response organization 316 at least in part by determining the quantity of emergency messages detected during the first time window exceeds a second threshold value. In the embodiment being described, the output module 308 may send a second notification message to the second emergency response organization 318 in response to detecting the second emergency message cluster. The second notification message may be originated by the output module 308 and directed to the second network address associated with the one or more second destination devices 320 at the second emergency response organization 318 via the communication network 312.

In still yet another exemplary embodiment of the network node 300, the cluster detecting logic 306 may detect a second emergency message cluster to the first emergency response organization 316 at least in part by determining the quantity of emergency messages detected during the first time window exceeds a second threshold value. In the embodiment being described, the output module 308 may send a second notification message to a third emergency response organization in response to detecting the second emergency message cluster. The second notification message may be originated by the output module 308 and directed to a third network address associated with one or more third destination devices at the third emergency response organization via the communication network 312.

In another exemplary embodiment of the network node 300, the message detecting logic 304 may detect the emergency messages during a second time window. In the embodiment being described, the cluster detecting logic 306 may detect a second emergency message cluster to the first emergency response organization 316 at least in part by determining a quantity of emergency messages detected during the second time window exceeds a second threshold value. The output module 308 may send a second notification message to the second emergency response organization 318 in response to detecting the second emergency message cluster. The second notification message may be originated by the output module 308 and directed to the second network address associated with the one or more second destination devices 320 at the second emergency response organization 318 via the communication network 312.

In the embodiment being described, the cluster detecting logic 306 may detect a third emergency message cluster to the first emergency response organization 316 at least in part by determining the quantity of emergency messages detected during the second time window exceeds a third threshold value. In this embodiment, the output module 308 may send a third notification message to the second emergency response organization 318 in response to detecting the third emergency message cluster. The third notification message may be originated by the output module 308 and directed to the second network address associated with the one or more second destination devices 320 at the second emergency response organization 318 via the communication network 312.

Alternatively, in the embodiment being described, the cluster detecting logic 306 may detect a third emergency message cluster to the first emergency response organization 316 at least in part by determining the quantity of emergency messages detected during the second time window exceeds a third threshold value. In this embodiment, the output module 308 may send a third notification message to a third emergency response organization in response to detecting the third emergency message cluster. The third notification message may be originated by the output module 308 and directed to a third network address associated with one or more third destination devices at the third emergency response organization via the communication network 312.

In yet another exemplary embodiment of the network node 300, the message detecting logic 304 may detect the emergency messages during a second time window. In the embodiment being described, the cluster detecting logic 306 may detect a second emergency message cluster to the first emergency response organization 316 at least in part by determining a quantity of emergency messages detected during the second time window exceeds a second threshold value. The output module 308 may send a second notification message to a third emergency response organization in response to detecting the second emergency message cluster. The second notification message may be originated by the output module 308 and directed to a third network address associated with one or more third destination devices at the third emergency response organization via the communication network 312.

In the embodiment being described, the cluster detecting logic 306 may detect a third emergency message cluster to the first emergency response organization 316 at least in part by determining the quantity of emergency messages detected during the second time window exceeds a third threshold value. In this embodiment, the output module 308 may send a third notification message to the third emergency response organization in response to detecting the third emergency message cluster. The third notification message may be originated by the output module 308 and directed to the third network address associated with the one or more third destination devices at the third emergency response organization via the communication network 312.

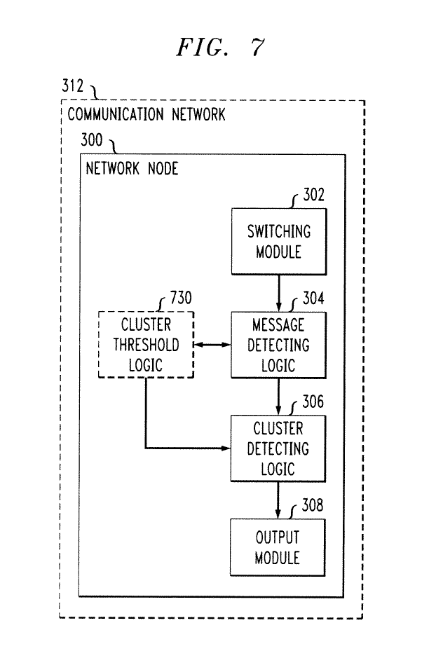

With reference to FIGS. 3 and 7, another exemplary embodiment of the network node 300 may include a cluster threshold logic 730 in operative communication with the message detecting logic 304. The cluster threshold logic 730 may analyze the emergency messages in relation to a chronological time period, determine a normal amount of emergency messages to the first emergency response organization in relation to the chronological time period, and determine an abnormal amount of emergency messages to the first emergency response organization in relation to the chronological time period. The abnormal amount may be offset from the normal amount by a margin defining a cluster threshold at which the first emergency response organization 316 desires to notify the second emergency response organization 318 of emergency message clusters. The cluster threshold logic 730 may communicate the chronological time period to the message detecting logic 304 to set the first time window. The cluster threshold logic 730 may communicate the abnormal amount to the cluster detecting logic 306 to set the first threshold value.

In the embodiment being described, the cluster threshold logic 730 may analyze the emergency messages in relation to a predetermined calendar cycle, determine the normal amount of emergency messages in relation to chronological segments of the predetermined calendar cycle, and determine the abnormal amount of emergency messages for each chronological segment. For example, calendar cycles may include a daily cycle for each day, each week, each month or each year; a weekly cycle for each week, each month or each year; a monthly cycle for each month or each year; or an annual cycle for each year. The chronological segment may be any time period less than the overall time for the predetermined calendar cycle and may be varied over the predetermined calendar cycle. The cluster threshold logic 730 may communicate the abnormal amounts determined for consecutive chronological segments to the cluster detecting logic 306 to vary the first threshold value over the predetermined calendar cycle.

Alternatively, in the embodiment being described, the cluster threshold logic 730 may analyze the emergency messages in relation to a predetermined schedule of events within a coverage area of the first emergency response organization, determine the normal amount of emergency messages in relation to chronological segments of the predetermined schedule of events, and determine the abnormal amount of emergency messages for each chronological segment. For example, events at a public stadium, arena, convention center, or another public facility may be scheduled; events at schools and churches may be scheduled; and work schedules (e.g., shift changes, work holidays, etc.) that have a significant impact on a geographic area may be scheduled. The chronological segment may be any time period less than the overall time for the predetermined schedule and may be varied over the predetermined schedule. The cluster threshold logic 730 may communicate the abnormal amounts determined for consecutive chronological segments to the cluster detecting logic 306 to vary the first threshold value over the predetermined schedule of events.

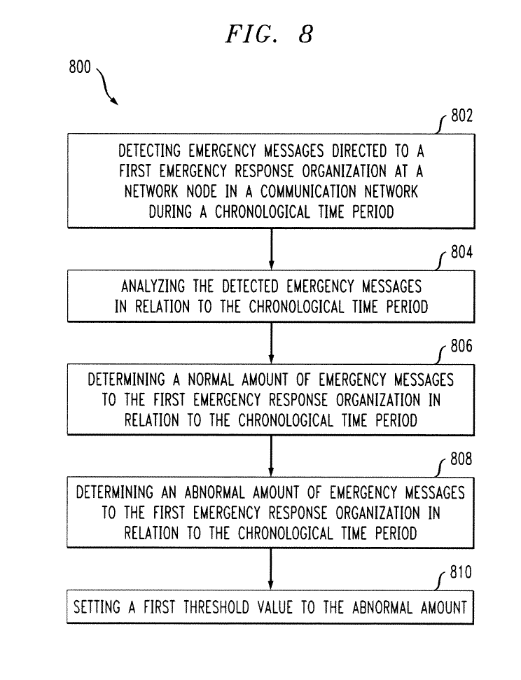

With reference to FIG. 8, another exemplary embodiment of a process 800 for notifying an emergency response organization of an emergency message cluster begins at 802 where emergency messages directed to a first emergency response organization at a network node in a communication network during a chronological time period may be detected. The emergency messages may be originated by user devices and directed to a first network address associated with one or more first destination devices at the first emergency response organization via the communication network through at least the network node.

At 804, the detected emergency messages may be analyzed in relation to the chronological time period. Next, a normal amount of emergency messages to the first emergency response organization in relation to the chronological time period may be determined (806). At 808, an abnormal amount of emergency messages to the first emergency response organization in relation to the chronological time period may be determined. The abnormal amount may be offset from the normal amount by a margin defining a cluster threshold at which the first emergency response organization desires to notify a second emergency response organization of emergency message clusters. At 810, a first threshold value may be set to the abnormal amount for subsequent detecting of emergency message clusters at the first emergency response organization.

In another embodiment exemplary embodiment, the process 800 may include analyzing the emergency messages detected in 802 in relation to a predetermined calendar cycle. For example, calendar cycles may include a daily cycle for each day, each week, each month or each year; a weekly cycle for each week, each month or each year; a monthly cycle for each month or each year; or an annual cycle for each year. In this embodiment, the normal amount of emergency messages in relation to chronological segments of the predetermined calendar cycle may be determined. The chronological segment may be any time period less than the overall time for the predetermined calendar cycle and may be varied over the predetermined calendar cycle. In the embodiment being described, the abnormal amount of emergency messages for each chronological segment may be determined. The first threshold value may be varied over the predetermined calendar cycle in relation to the abnormal amounts determined for consecutive chronological segments.

In yet another exemplary embodiment, the process 800 may include analyzing the emergency messages detected in 802 in relation to a predetermined schedule of events within a coverage area of the first emergency response organization. For example, events at a public stadium, arena, convention center, or another public facility may be scheduled; events at schools and churches may be scheduled; and work schedules (e.g., shift changes, work holidays, etc.) that have a significant impact on a geographic area may be scheduled. In this embodiment, the normal amount of emergency messages in relation to chronological segments of the predetermined schedule of events may be determined. The chronological segment may be any time period less than the overall time for the predetermined schedule and may be varied over the predetermined schedule. In the embodiment being described, the abnormal amount of emergency messages for each chronological segment may be determined. The first threshold value may be varied over the predetermined schedule of events in relation to the abnormal amounts determined for consecutive chronological segments.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for notifying an emergency response organization of an emergency message cluster, comprising:
a) detecting emergency messages directed to a first emergency response organization at a network node in a communication network during a first time window, wherein the emergency messages are originated by user devices and directed to a first network address associated with one or more first destination devices at the first emergency response organization via the communication network through at least the network node;
b) detecting a first emergency message cluster to the first emergency response organization at least in part by determining a quantity of emergency messages detected during the first time window exceeds a first threshold value; and
c) sending a first notification message to a second emergency response organization in response to the first emergency message cluster being detected, wherein the first notification message is originated by the network node and directed to a second network address associated with one or more second destination devices at the second emergency response organization via the communication network.

2. The method of claim 1 wherein the first notification message in c) includes information indicative of a geographic area representative of at least a portion of a coverage area serviced by the network node, an elapsed time in relation to the first time window and detection of the first emergency message cluster, and the quantity of emergency messages detected in relation to the first time window and detection of the first emergency message cluster.

3. The method of claim 1, further comprising:
d) collecting location information for at least a portion of the emergency messages detected in a), the location information indicative of a geographic location of the corresponding user device from which the emergency message originated; and
e) analyzing the collected location information in relation to one or more geographic areas and corresponding geographic threshold values for the one or more geographic area in relation to the first time window to determine if emergency messages originating from any geographic area of the one or more geographic areas exceed the corresponding geographic threshold value;
wherein the first emergency message cluster in b) is detected at least in part by determining that emergency messages originating from at least one geographic area of the one or more geographic areas during the first time window exceeded the corresponding threshold value;
wherein the first notification message in c) includes the corresponding location information for the at least one geographic area contributing to detection of the first emergency message cluster in b).

4. The method of claim 3 wherein the location information in d) accompanies the corresponding emergency messages at the network node, the method further comprising:
f) capturing the accompanying location information from the corresponding emergency messages.

5. The method of claim 3 wherein an originating network address accompanies the emergency messages at the network node for which the location information in d) is collected, the method further comprising:
f) retrieving the location information in d) from a database accessible to the network node via the communication network based at least in part on the corresponding originating network address, wherein the database relates the originating network address to the corresponding location information.

6. The method of claim 1 wherein the first time window is defined by a predetermined fixed duration that shifts in relation to perpetual time such that the quantity of emergency messages associated with the first time window are counted on a first-in-first-out basis.

7. The method of claim 1 wherein the first notification message in c) facilitates initiation of a predetermined response protocol by the second emergency response organization in relation to the first emergency message cluster.

8. The method of claim 1, further comprising:
d) detecting a second emergency message cluster to the first emergency response organization at least in part by determining the quantity of emergency messages detected during the first time window exceeds a second threshold value; and
e) sending a second notification message to the second emergency response organization in response to detecting the second emergency message cluster, wherein the second notification message is originated by the network node and directed to the second network address associated with the one or more second destination devices at the second emergency response organization via the communication network.

9. The method of claim 1, further comprising:
d) detecting a second emergency message cluster to the first emergency response organization at least in part by determining the quantity of emergency messages detected during the first time window exceeds a second threshold value; and
e) sending a second notification message to a third emergency response organization in response to detecting the second emergency message cluster, wherein the second notification message is originated by the network node and directed to a third network address associated with one or more third destination devices at the third emergency response organization via the communication network.

10. The method of claim 1, further comprising:
d) detecting the emergency messages in a) during a second time window;
e) detecting a second emergency message cluster to the first emergency response organization at least in part by determining a quantity of emergency messages detected during the second time window exceeds a second threshold value; and
f) sending a second notification message to the second emergency response organization in response to detecting the second emergency message cluster, wherein the second notification message is originated by the network node and directed to the second network address associated with the one or more second destination devices at the second emergency response organization via the communication network.

11. The method of claim 1, further comprising:
d) detecting the emergency messages in a) during a second time window;
e) detecting a second emergency message cluster to the first emergency response organization at least in part by determining a quantity of emergency messages detected during the second time window exceeds a second threshold value; and
f) sending a second notification message to a third emergency response organization in response to detecting the second emergency message cluster, wherein the second notification message is originated by the network node and directed to a third network address associated with one or more third destination devices at the third emergency response organization via the communication network.

12. The method of claim 1, further comprising:
d) analyzing the emergency messages detected in a) in relation to a chronological time period;
e) determining a normal amount of emergency messages to the first emergency response organization in relation to the chronological time period;
f) determining an abnormal amount of emergency messages to the first emergency response organization in relation to the chronological time period, wherein the abnormal amount is offset from the normal amount by a margin defining a cluster threshold at which the first emergency response organization desires to notify the second emergency response organization of emergency message clusters;
g) setting the first time window to the chronological time period; and
h) setting the first threshold value to the abnormal amount.

13. An apparatus within a communication network for notifying an emergency response organization of an emergency message cluster, comprising:
a switching module for handling emergency messages originated by user devices via the communication network, wherein the emergency messages are directed to a first network address associated with one or more first destination devices at a first emergency response organization via the communication network;
a message detecting logic in operative communication with the switching module for detecting the emergency messages directed to the first emergency response organization during a first time window;
a cluster detecting logic in operative communication with the message detecting logic for detecting a first emergency message cluster to the first emergency response organization at least in part by determining a quantity of emergency messages detected during the first time window exceeds a first threshold value; and
an output module in operative communication with the cluster detecting logic for sending a first notification message to a second emergency response organization in response to the first emergency message cluster being detected, wherein the first notification message is originated by the output module and directed to a second network address associated with one or more second destination devices at the second emergency response organization via the communication network.

14. The apparatus of claim 13, further comprising:
a location collection logic in operative communication with the message detecting logic for collecting location information for at least a portion of the emergency messages, the location information indicative of a geographic location of the corresponding user device from which the emergency message originated;
wherein the cluster detecting logic is in operative communication with the location collection logic and for analyzing the collected location information in relation to one or more geographic areas and corresponding geographic threshold values for the one or more geographic area in relation to the first time window to determine if emergency messages originating from any geographic area of the one or more geographic areas exceed the corresponding geographic threshold value;
wherein the first emergency message cluster is detected at least in part by determining that emergency messages originating from at least one geographic area of the one or more geographic areas during the first time window exceeded the corresponding threshold value;
wherein the first notification message includes the corresponding location information for the at least one geographic area contributing to detection of the first emergency message cluster.

15. The apparatus of claim 13, further comprising:
a destination serving module in operative communication with the switching module for serving the first emergency response organization and for sending the emergency messages to the one or more first destination devices via the communication network.

16. The apparatus of claim 13, the input module comprising:
an origination serving module in operative communication with the switching module for serving the user devices from which the emergency messages are originated and for receiving the emergency messages from the user devices via the communication network.

17. The apparatus of claim 13, further comprising:
a cluster threshold logic in operative communication with the message detecting logic for analyzing the emergency messages in relation to a chronological time period, determining a normal amount of emergency messages to the first emergency response organization in relation to the chronological time period, and determining an abnormal amount of emergency messages to the first emergency response organization in relation to the chronological time period, wherein the abnormal amount is offset from the normal amount by a margin defining a cluster threshold at which the first emergency response organization desires to notify the second emergency response organization of emergency message clusters;
wherein the cluster threshold logic is in operative communication with the message detecting logic for setting the first time window to the chronological time period; and
wherein the cluster threshold logic is in operative communication with the cluster detecting logic for setting the first threshold value to the abnormal amount.

18. A method for notifying an emergency response organization of an emergency message cluster, comprising:
a) detecting emergency messages directed to a first emergency response organization at a network node in a communication network during a chronological time period, wherein the emergency messages are originated by user devices and directed to a first network address associated with one or more first destination devices at the first emergency response organization via the communication network through at least the network node;
b) analyzing the detected emergency messages in relation to the chronological time period;
c) determining a normal amount of emergency messages to the first emergency response organization in relation to the chronological time period;
d) determining an abnormal amount of emergency messages to the first emergency response organization in relation to the chronological time period, wherein the abnormal amount is offset from the normal amount by a margin defining a cluster threshold at which the first emergency response organization desires to notify a second emergency response organization of emergency message clusters; and
e) setting a first threshold value to the abnormal amount for subsequent detecting of emergency message clusters at the first emergency response organization.

19. The method of claim 18, further comprising:
f) analyzing the emergency messages detected in a) in relation to a predetermined calendar cycle;
g) determining the normal amount of emergency messages in relation to chronological segments of the predetermined calendar cycle;
h) determining the abnormal amount of emergency messages for each chronological segment; and
i) varying the first threshold value over the predetermined calendar cycle in relation to the abnormal amounts determined for consecutive chronological segments.

20. The method of claim 18, further comprising:
f) analyzing the emergency messages detected in a) in relation to a predetermined schedule of events within a coverage area of the first emergency response organization;
g) determining the normal amount of emergency messages in relation to chronological segments of the predetermined schedule of events;
h) determining the abnormal amount of emergency messages for each chronological segment; and
i) varying the first threshold value over the predetermined schedule of events in relation to the abnormal amounts determined for consecutive chronological segments.
